(19) United States
(12) Patent Application Publication
(10) Pub. No.: US 2017/0047878 A1
(43) Pub. Date: Feb. 16, 2017

(54) Portable Power Supply System

(71) Applicant: Allen Hall, Osceola, AR (US)

(72) Inventor: Allen Hall, Osceola, AR (US)

(21) Appl. No.: 14/826,846

(22) Filed: Aug. 14, 2015

(51) Int. Cl. H02P 27/06; H02M 7/44

(52) U.S. Cl. CPC H02P 27/06; H02M 7/44

(57) ABSTRACT

A portable power supply system powers electrical devices in remote areas where electrical connection to an existing power grid is not possible. The system includes a battery positioned in an interior space of a housing. An inverter is coupled to the housing and electrically coupled to the battery. A motor is positioned in the interior space and electrically coupled to the inverter wherein the motor is powered by the inverter. An alternator is positioned in the interior space and turned by the motor. The alternator is electrically coupled to the battery providing a charging current to the battery. An outlet is electrically coupled to the inverter to provide electrical power to an extrinsic device plugged into the outlet.

### BACKGROUND OF THE DISCLOSURE

### Field of the Disclosure

The disclosure relates to power supply devices and more particularly pertains to a new power supply device for powering electrical devices in remote areas where electrical connection to an existing power grid is not possible.

### SUMMARY OF THE DISCLOSURE

An embodiment of the disclosure meets the needs presented above by generally comprising a battery positioned in an interior space of a housing. An inverter is coupled to the housing and electrically coupled to the battery. A motor is positioned in the interior space and electrically coupled to the inverter wherein the motor is powered by the inverter. An alternator is positioned in the interior space and turned by the motor. The alternator is electrically coupled to the battery providing a charging current to the battery. An outlet is electrically coupled to the inverter to provide electrical power to an extrinsic device plugged into the outlet.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF THE DRAWINGS

The disclosure will be better understood and objects other than those set forth above will become apparent when consideration is given to the following detailed description thereof. Such description makes reference to the annexed drawings wherein:

FIG. 1 is a top front side perspective view of a portable power supply system according to an embodiment of the disclosure.

FIG. 2 is a partial cut-away front view of an embodiment of the disclosure.

FIG. 3 is a partial cut-away top view of an embodiment of the disclosure.

FIG. 4 is a schematic view of an embodiment of the disclosure.

### DESCRIPTION OF THE PREFERRED EMBODIMENT

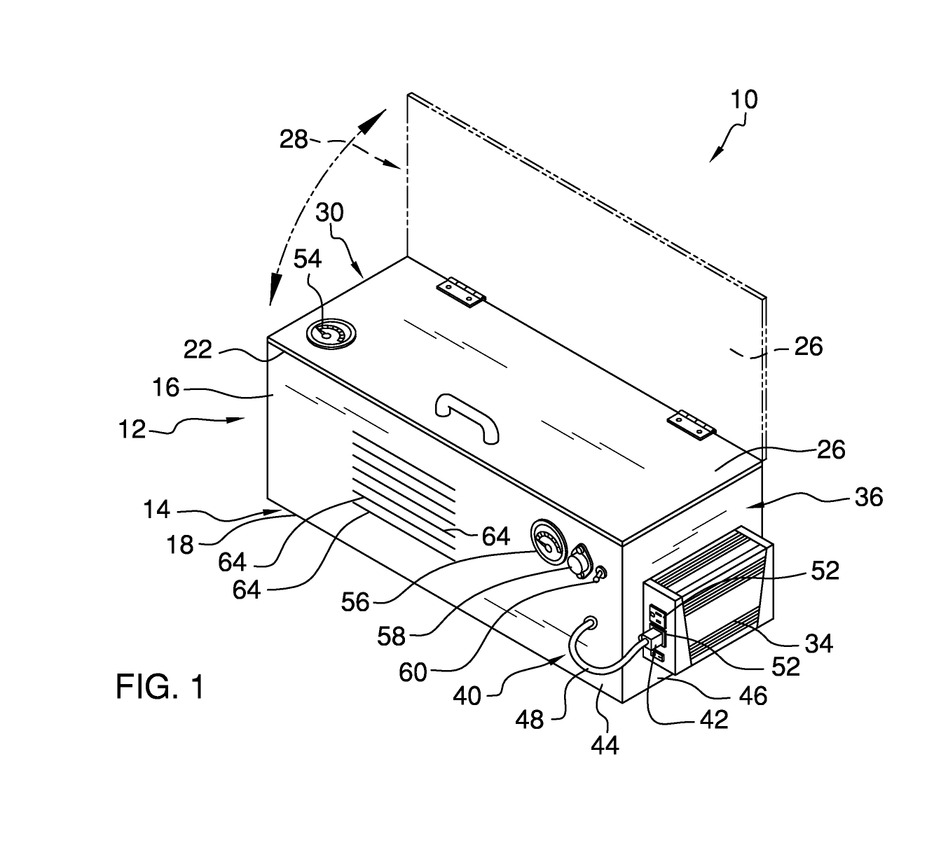

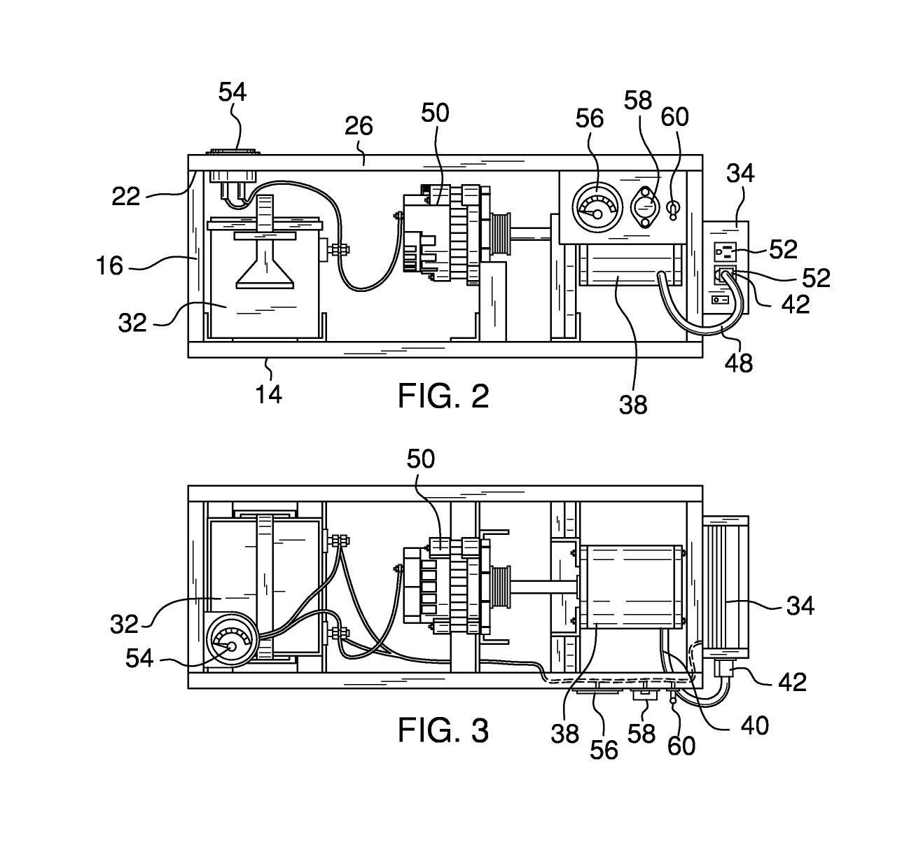

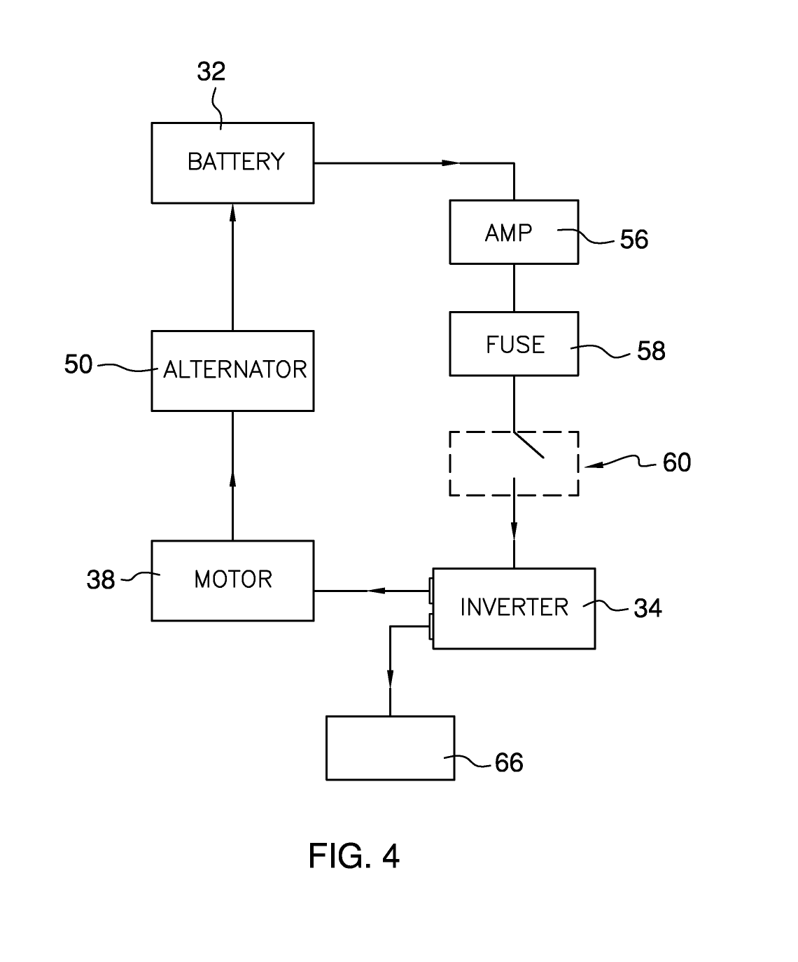

With reference now to the drawings, and in particular to FIGS. 1 through 4 thereof, a new power supply device embodying the principles and concepts of an embodiment of the disclosure and generally designated by the reference numeral 10 will be described.

As best illustrated in FIGS. 1 through 4, the portable power supply system 10 generally comprises a housing 12 having a bottom wall 14 and a perimeter wall 16 coupled to and extending upwardly from a perimeter edge 18 of the bottom wall 14 defining an interior space 20 of the housing 12. An upper edge 22 of the perimeter wall 16 defines an opening 24 into the interior space 20 of the housing 12. The housing 12 includes a lid 26 pivotally coupled to the perimeter wall 16. The lid 26 is pivotable between an open position 28 exposing the interior space 20 and a closed position 30 covering the opening 24 into the interior space 20. A battery 32 is positioned in the interior space 20. The battery 32 may be a 12 volt battery and may be secured to the housing 12. An inverter 34 is coupled to the housing 12. The inverter 34 is electrically coupled to the battery 32 wherein the battery 32 provides electrical current to the inverter 34. The inverter 34 is coupled to an exterior face 36 of the perimeter wall 16 of the housing 12. Each of a plurality of outlets 52 is electrically coupled to and exposed on the inverter 34 wherein each outlet 52 is configured to provide electrical power to an extrinsic device 66 plugged into one of the outlets 52.

A motor 38 is positioned in the interior space 20. The motor 38 is an alternating current type motor electrically coupled to the inverter 34 wherein the motor 38 is powered by the inverter 34. A power cord 40 is electrically coupled to the motor 38. A distal end 42 of the power cord 40 forms a plug and is plugged into one of the outlets 52 of the inverter 34 wherein the inverter 34 provides alternating electrical current back to the motor 38. The cord 40 extends through the perimeter wall 16. The cord 40 may extend through a front face 44 of the perimeter wall 16 while the inverter 34 is positioned on a side face 46 adjacent to the front face 44. Thus, an exterior section 48 of the cord 40 relative to the housing 12 can be readily grasped to disengage the cord 40 from the inverter 34 if desired. An alternator 50 is positioned in the interior space 20. The alternator 50 is operationally coupled to the motor 38 wherein the alternator 50 is turned by the motor 38. The alternator 50 is electrically coupled to the battery 32 wherein the alternator 50 provides a charging current to the battery 32.

A voltage gauge 54 is coupled to the housing 12. The voltage gauge 54 is electrically coupled to the battery 32. An amperage gauge 56 is coupled to the housing 12. The amperage gauge 56 is electrically coupled in series between the battery 32 and the inverter 34 wherein the amperage gauge 56 is configured to display a level of amperage provided by the battery 32 to the inverter 34. A fuse 58 is coupled to the housing 12. The fuse 58 is electrically coupled in series between the battery 32 and the inverter 34. The fuse 58 is positioned on an exterior of the housing 12 wherein the fuse 58 is configured to be replaceable from outside of the housing 12. A switch 60 is positioned on the housing 12. The switch 60 is electrically coupled in series between the battery 32 and the inverter 34. A handle 62 is coupled to the lid 26. Each of a plurality of vents 64 extends through the perimeter wall 16 of the housing 12.

In use, the housing 12 may be carried to a desired location. The cord 40 is attached to the inverter 34 and the switch 60 is manipulated to allow current from the battery 32 to the inverter 34. The inverter 34 may then be used to provide alternating current through the outlets 52. The size, type and power of the battery 32, inverter 34, and motor 38 may be scaled as needed to provide systems 10 capable of handling power requirements for various situations.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

1. A portable power supply system comprising:
a housing having a bottom wall and a perimeter wall coupled to and extending upwardly from a perimeter edge of said bottom wall defining an interior space of said housing;
a battery positioned in said interior space;
an inverter coupled to said housing, said inverter being electrically coupled to said battery wherein battery provides electrical current to said inverter, said inverter being coupled to an exterior face of said perimeter wall of said housing;
a motor positioned in said interior space, said motor being electrically coupled to said inverter wherein said motor is powered by said inverter;
an alternator positioned in said interior space, said alternator being operationally coupled to said motor wherein said alternator is turned by said motor, said alternator being electrically coupled to said battery wherein said alternator provides a charging current to said battery;
an outlet electrically coupled to said inverter wherein said outlet is configured to provide electrical power to an extrinsic device plugged into said outlet; and
a power cord being electrically coupled to said motor, a distal end of said power cord being plugged into said inverter wherein said inverter provides alternating electrical current back to said motor, and said cord extending through said perimeter wall.

2. The system of claim 1, further comprising said outlet being one of a plurality of outlets electrically coupled to said inverter.

3. (canceled)

4. The system of claim 1, further comprising a voltage gauge coupled to said housing, said voltage gauge being electrically coupled to said battery.

5. The system of claim 1, further comprising an amperage gauge coupled to said housing, said amperage gauge being electrically coupled in series between said battery and said inverter wherein said amperage gauge is configured to display a level of amperage provided by said battery to said inverter.

6. The system of claim 1, further comprising a fuse coupled to said housing, said fuse being electrically coupled in series between said battery and said inverter.

7. The system of claim 6, further comprising said fuse being positioned on an exterior of said housing wherein said fuse is configured to be replaceable from outside of said housing.

8. The system of claim 1, further comprising a switch positioned on said housing, said switch being electrically coupled in series between said battery and said inverter.

9. The system of claim 1, further comprising:
an upper edge of said perimeter wall defining an opening into said interior space of said housing; and
said housing including a lid being pivotally coupled to said perimeter wall, said lid being pivotable between an open position exposing said interior space and a closed position covering said opening into said interior space.

10. The system of claim 9, further comprising a handle coupled to said lid.

11. The system of claim 1, further comprising a plurality of vents extending through said perimeter wall of said housing.

12. A portable power supply system comprising:
a housing having a bottom wall and a perimeter wall coupled to and extending upwardly from a perimeter edge of said bottom wall defining an interior space of said housing, an upper edge of said perimeter wall defining an opening into said interior space of said housing, said housing including a lid being pivotally coupled to said perimeter wall, said lid being pivotable between an open position exposing said interior space and a closed position covering said opening into said interior space;
a battery positioned in said interior space;
an inverter coupled to said housing, said inverter being electrically coupled to said battery wherein battery provides electrical current to said inverter, said inverter being coupled to an exterior face of said perimeter wall of said housing;
a motor positioned in said interior space, said motor being electrically coupled to said inverter wherein said motor is powered by said inverter;
a power cord being electrically coupled to said motor, a distal end of said power cord being plugged into said inverter wherein said inverter provides alternating electrical current back to said motor, and said cord extending through said perimeter wall;
an alternator positioned in said interior space, said alternator being operationally coupled to said motor wherein said alternator is turned by said motor, said alternator being electrically coupled to said battery wherein said alternator provides a charging current to said battery; and
a plurality of outlets, each outlet being electrically coupled to said inverter wherein each said outlet is configured to provide electrical power to an extrinsic device plugged into said outlet;
a voltage gauge coupled to said housing, said voltage gauge being electrically coupled to said battery;
an amperage gauge coupled to said housing, said amperage gauge being electrically coupled in series between said battery and said inverter wherein said amperage gauge is configured to display a level of amperage provided by said battery to said inverter;
a fuse coupled to said housing, said fuse being electrically coupled in series between said battery and said inverter, said fuse being positioned on an exterior of said housing wherein said fuse is configured to be replaceable from outside of said housing;
a switch positioned on said housing, said switch being electrically coupled in series between said battery and said inverter;
a handle coupled to said lid; and
a plurality of vents extending through said perimeter wall of said housing.
